(19) United States
(12) Patent Application Publication
(10) Pub. No.: US 2007/0068631 A1
(43) Pub. Date: Mar. 29, 2007

(54) Tyre building drum

(76) Inventor: Brian Painter, West Midlands (GB)

Correspondence Address: WELLS ST. JOHN P.S., 601 W. FIRST AVENUE, SUITE 1300, SPOKANE, WA, 99201, US

(21) Appl. No.: 11/238,138

(22) Filed: Sep. 28, 2005

(51) Int. Cl. B29D 30/18

(52) U.S. Cl. 156/402

(57) ABSTRACT

A roller turn up mechanism for the forming of a bead section in a tyre built on a tyre building drum is disclosed. It is known to provide a tyre building drum with two ring segments each placed on opposing sides of a central axis, means to expand that part of the tyre material between the ring segments, and means on each side of the ring segments to press that part of the tyre material outside of the ring segments against the expanded part of the tyre material within the ring segments, thereby to wrap each bead ring within the tyre carcass formed thereby. The pressing of that part of the tyre material outside of the ring segments may be performed by a plurality of rollers mounted on equiangularly spaced pivoting arms disposed axially about the tyre building drum. However, there is a tendency as the roller arms are driven up the sides of the carcass being formed for the roller arms to diverge causing problems in manufacture. A roller turn up mechanism is disclosed in which each pivoting roller arm is provided with a first set of rollers of a first axial length and a second set of rollers of a second axial length, such that the first and seconds sets of rollers of adjacent pivoting roller arms are alternated such that an overlap between the first and second sets of rollers of a first pivoting roller arm and the first and second sets of rollers of an adjacent pivoting roller arm is maintained as the pivoting roller arms are driven radially outward and begin to diverge.

The present invention relates to improvements in a tyre building drum, and in particular in a roller turn up mechanism for the forming of a bead section in a tyre built on such a tyre building drum.

Vehicle tyres include tyre beads which define the inner diameter of the tyre, and provide a pair of circular, parallel, coaxial, substantially inextensible edges whereby the tyre is seated, in use, on a wheel rim. Conventionally tyre beads are each defined by a substantially inextensible circular bead ring around which tyre carcass material is wrapped. Bead rings are conventionally formed from steel wire, but can be formed from textile filaments.

Tyre carcasses are produced by providing tyre material such as rubber to a tyre building drum where the tyre carcass is built up to include the tyre beads.

It is known to provide a tyre building drum with a central axis, two ring segments each placed on opposing sides of the axis each for supporting a bead ring, means to expand that part of the tyre material between the ring segments, and means on each side of the ring segments to press that part of the tyre material outside of the ring segments against the expanded part of the tyre material within the ring segments, thereby to wrap each bead ring within the tyre carcass formed thereby. Typically the expansion of that part of the tyre between the ring segments is caused by inflating that part of the tyre to the general shape of a tyre carcass. The pressing of that part of the tyre material outside of the ring segments against the expanded part of the tyre material may be performed by a plurality of relatively narrow rollers mounted on equiangularly spaced pivoting arms disposed axially about the tyre building drum.

The pivoting arms are typically driven axially towards a respective ring segment, contact of the rollers with the tyre material causing the arms to pivot and drive the rollers radially outwards to push that part of the tyre material outside of the ring segments against the expanded part of the tyre material.

However, there is a tendency as the roller arms are driven up the sides of the carcass being formed for the roller arms to diverge. Stitching or sealing of that part of the tyre material outside of the ring segments against the expanded part of the tyre material occurs where the rollers push the two parts of the tyre material together. The rollers are moved from the region of the bead rings, that is the radial inner part of the tyre carcass being formed, axially outward to the radially outer part of the tyre carcass being formed. Thus it may be seen that as the rollers move radially outward the roller arms and the rollers diverge, gaps or incomplete regions of stitching develop. Additionally, there is a risk that air trapped between the two parts of the tyre material might not properly be expelled leading to a manufacturing defect in the tyre carcass.

It is an advantage of the present invention that this problem is overcome.

In accordance with the present invention, a roller turn up mechanism comprises a plurality of pivoting roller arms, each pivoting roller arm being provided with a first set of rollers of a first axial length and a second set of rollers of a second axial length, such that in use, the first and seconds sets of rollers of adjacent pivoting roller alms are alternated, each first set of rollers and second set of rollers mounted on a particular pivoting roller arm are supported on a carriage pivotally mounted to the particular pivoting roller arm.

This has as an advantage that as the pivoting roller arms are driven radially outward and begin to diverge an overlap between the first and second sets of rollers of a first pivoting roller arm and the first and second sets of rollers of an adjacent pivoting roller arm is maintained. As a result there is no area of that part of the tyre material outside of the ring segments that is not pressed against the expanded part of the tyre material. As a result the risk of air being trapped between the two parts of the tyre material forming the tyre carcass is substantially reduced.

Preferably, the carriage is biased in a particular orientation towards a rest position.

More preferably, the carriage is biased by an extension spring.

Preferably, the pivoting movement of the carriage is limited. More preferably, the limit of the pivoting movement of the carriage is provided by a cam arrangement acting in cooperation with a stop peg.

The invention will now be described, by way of example only, with reference to the accompanying drawings, in which:

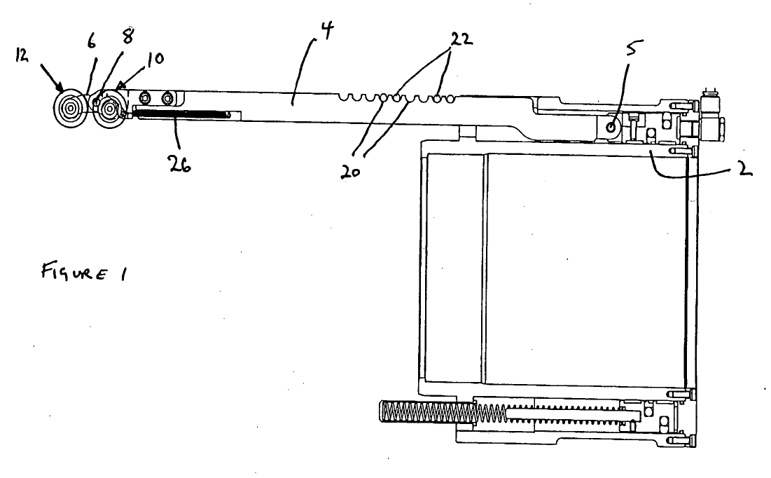

FIG. 1 shows a side section through an arm assembly forming part of a roller turn up mechanism for a mounting on a drum shaft;

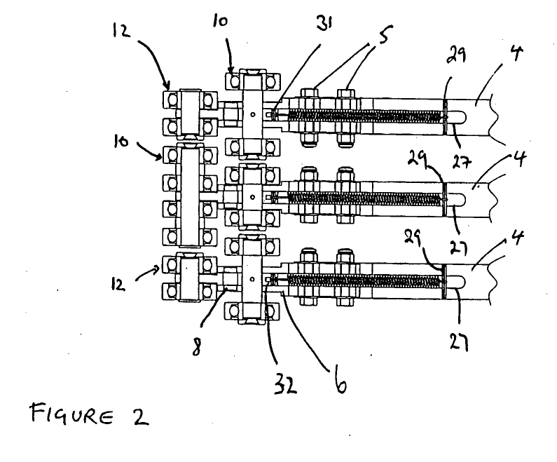

FIG. 2 shows a plan view of a series of arms of the turn up device;

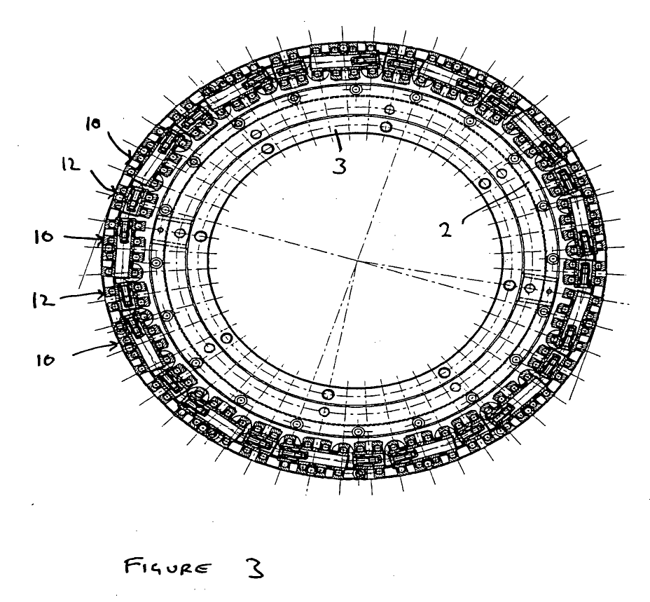

FIG. 3 shows an end view of the roller turn up assembly with the arms in a fully deflected position; and

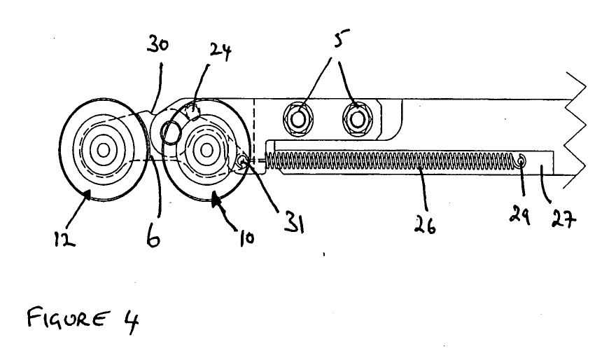

FIG. 4 shows a detail of the arm assembly shown in FIG. 1.

The roller turn up mechanism illustrated with reference to the drawings is described in the context of a bead lock drum, the invention is suitable for use with other forms of tyre building apparatus. The bead lock drum is intended to be used in amalgamating a first stage tyre carcass to a belt and tread package. This method of tyre construction is well known and thus will only be described to the extent necessary to achieve a full understanding of the roller turn-up mechanism and a tyre building drum incorporating such a mechanism.

Corresponding roller turn up mechanisms are provided to each side of the tyre building drum. For the sake of convenience only a roller turn up mechanism for use on one side of the tyre building drum will be described. It will be understood that a similar roller turn up mechanism can be provided to the other side of the tyre building drum.

Referring first to FIG. 1, there is shown in side section an arm assembly forming part of a roller turn up mechanism in accordance with the present invention. A cylinder 2 mounted for adjustable axial movement on a drum shaft 3 (FIG. 3) is provided. A plurality of pivoting roller arms 4 are mounted circumferentially about the cylinder 2. Each of the pivoting roller arms 4 is both capable of being driven axially along the cylinder 2 in the direction of the drum shaft, but is also pivotally mounted to enable the pivoting roller arms 4 to pivot in the radial direction of the tyre building drum.

Each pivoting roller arm 4 is mounted at a first end to the cylinder about a pivot 5. The pivot 5 is adapted to move within axially within the cylinder 2 from a rest position in which pivoting of the pivoting roller arm 4 is prevented to a second position at which pivoting of the pivoting roller arm 4 is permitted. Each pivoting roller arm 4 may be formed as a single piece or of two pieces as shown in the Figures. By forming the pivoting roller arms 4 of two pieces the mounting of a carriage 6 at a second free end of the pivoting roller arm is facilitated.

The carriage 6 is mounted to the pivoting roller arm 4 about a pivot pin 8. The pivot pin 8 is conveniently formed in the second piece of the pivoting roller arm 4, the first and second pieces of the pivoting roller arm 4 being secured together in any convenient manner, such as by bolts 5. Each carriage 6 has a first set of rollers 10 and a second set of rollers 12. The first set of rollers 10 are of a first length and are mounted on a first shaft 14 and the second set of rollers 12 are of a second length and are mounted on a second shaft 16 such that each set of rollers 10, 12 is free to rotate about a respective shaft 14, 16. As may be seen from FIG. 2, each set of the first and second rollers 10, 12 are arranged alternatively on adjacent pivoting roller arms 4. In this way two rings of rollers are formed about the cylinder 2, with the gaps in the inner ring being matched by a roller disposed in the outer ring and the gaps in the outer ring being matched by a roller disposed in the inner ring. As a result as turn up proceeds and the arms spread in the radial direction of the tyre building drum, no gaps develop between the pivoting roller arms ensuring uniform pressing of the roller turn up.

The pressing force transmitted from the cylinder 2 through each pivoting roller arm 4 is distributed to each of the first and second sets of rollers 10, 12.

A grooved section 20 is provided on each pivoting roller arm 4. Elastic belts 22 are disposed in the grooved sections 20 to ensure sufficient pressing force on the first and second sets of rollers 10, 12 if the pivoting roller arms 4 are overextended when opening.

In use, the pressing force exerted by the first and second sets of rollers 10,12 on the turned up section of the tyre carcass is evenly distributed thereby eliminating non-uniform pressing.

Operation of the roller turn up mechanism will now be described in relation to the manufacture of a tyre carcass. A first stage tyre carcass is positioning known manner coaxial with the tyre building drum. The carcass includes tyre beads and these are located to overlie bead seating rings of the tyre building drum. With the beads seated in the bead seating rings the carcass is deformed to take the general shape of a tyre. The carcass may be deformed by inflating the carcass or by being deformed in some other way. The pressing of that part of the tyre material outside of the ring segments against the expanded part of the tyre material is then performed.

The pivoting roller arms 4 are disposed such that that part of the tyre material outside of the ring segments overlies the roller arms. The roller arms are initially moved axially inwardly until they meet the portion of the tyre carcass material adjacent the bead seating rings. Further inward movement of the pivot point of the pivoting roller arms causes the pivoting roller arms to pivot and the free end of the pivoting roller arms to move radially outwards causing that part of the tyre material outside of the ring segments to be rolled up and pressed against the deformed portion of tyre material. The arrangement of the first and second set of rollers 10, 12 ensures that at least one of the first and second sets of rollers 10, 12 is in contact with the tyre material being rolled up and allows the application of even pressure in response to the shape of the bead section.

The arrangement of the first and second set of rollers 10, 12 also allows pressing without gaps that is regions of non-uniform pressing forming in the direction of the tyre circumference and thereby prevents pockets of air being formed in the side walls of the tyre being formed.

When the tyre carcass is formed the pivoting roller arms 4 are returned together with the cylinder 2 to their original rest position and the ‘green’ tyre removed from the tyre building drum for vulcanisation. In order to prevent the carriage 6 pivoting to a position other than its rest position, a return means in the form of an extension spring 26 is provided. The extension spring 26 is mounted in a suitable recess 27 in the pivoting roller arm 4, with a first end of the extension spring 26 being connected to the pivoting roller arm 4 (for example by way of a pin 29 mounted in the recess 27) and a second end of the extension spring 26 being connected to a first end of the carriage 6 (for

example by way of a pin 31 mounted in a suitable recess 32 in the carriage 6). Additionally to prevent the extension spring 26 from becoming overextended, the pivoting movement of the carriage 6 is limited. This limitation may conveniently be provided by the use of a stop pin 28 (as best seen in FIG. 4) provided on the pivoting roller arm 4. The carriage 6 is provided with a carrying surface 30 having first and second ends for abutment with the stop pin. The camming surface 30 is so shaped to limit the pivoting of the carriage 6 between a rest position (as shown in FIGS. 1 and 4) and a position of maximum deflection. The second position is so chosen to allow turn up to proceed to the maximum extent required.

Biasing of the carriage 6 also ensures that variations in the surface unevenness may be accommodated such that excessive force is not applied to the carcass and non-uniform regions of the carcass can thereby be reduced.

Biasing of the carriage 6 to the rest position ensures that when the pivoting roller arms 4 are withdrawn to allow removal of the ‘green’ tyre carcass ensures that the carriage 6 is returned to its rest position in preparation for the next tyre forming operation. By limiting the range of movement of the carriage 6, the carriage 6 is able to be returned to its rest position solely by the action of the biasing means.

I claim:

1. A roller turn up mechanism comprises a plurality of pivoting roller arms, each pivoting roller arm being provided with a first set of rollers of a first axial length and a second set of rollers of a second axial length, such that in use, the first and seconds sets of rollers of adjacent pivoting roller arms are alternated, each first set of rollers and second set of rollers mounted on a particular pivoting roller arm are supported on a carriage pivotally mounted to the particular pivoting roller arm.

2. A roller turn up mechanism according to claim 1, in which the carriage is biased in a particular orientation towards a rest position.

3. A roller turn up mechanism according to claim 2, in which the carriage is biased by an extension spring.

4. A roller turn up mechanism according to claim 1, in which the pivoting movement of the carriage is limited.

5. A roller turn up mechanism according to claim 4, in which the limit of the pivoting movement of the carriage is provided by a cam arrangement acting in cooperation with a stop peg.
